(19) United States
(12) Patent Application Publication
(10) Pub. No.: US 2012/0159206 A1
(43) Pub. Date: Jun. 21, 2012

(54) INFORMATION PROCESSOR

(75) Inventors: Takeshi Endo, Nagano (JP); Daisuke Kawamoto, Nagano (JP)

(73) Assignee: SONY CORPORATION, Tokyo (JP)

(21) Appl. No.: 13/314,656

(22) Filed: Dec. 8, 2011

(30) Foreign Application Priority Data
Dec. 20, 2010 (JP) P2010-283252

(51) Int. Cl. G06F 1/26

(52) U.S. Cl. 713/310

(57) ABSTRACT

Disclosed herein is an information processor, including: a detecting portion detecting connection between a battery pack and an information processor main body, and outputting connection information to the battery pack; a power source circuit to which an electric power is supplied from the battery pack acquiring the connection information; a manipulation portion adapted to be manipulated by a user; and a stopping portion outputting un-connection information to the battery pack when the manipulation portion is manipulated, and stopping output of the connection information even when the connection is detected by the detecting portion.

### BACKGROUND

The present disclosure relates to an information processor, such as a notebook-size personal computer, to which a battery pack is attached.

A notebook-size personal computer to/from which a battery pack can be readily attached/detached is the mainstream in such a notebook-size personal computer. In general, a battery attachment portion to which a battery pack is detachably attached is provided on a back surface of a main body portion of the notebook-size personal computer. The battery pack is inserted in a direction approximately parallel with a bottom surface of the main body portion of the notebook-size personal computer to be attached to the battery pack attachment portion. The battery pack attachment portion has a connector. The connector of the battery pack attachment portion, and a connector which the battery pack has are connected to each other, thereby connecting the main body portion of the notebook-size personal computer, and the battery pack to each other. This technique, for example, is disclosed in Japanese Patent Laid-Open No. 2010-157442.

As described above, the notebook-size personal computer includes the battery pack which is detachably attached to the main body portion (main body unit). The main body unit is equipped with a printed wiring board having plural electronic parts or components and the like mounted thereto, a heat dissipation unit, a drive class such as an HDD or a Solid State Drive (SSD), and the like. Also, a Central Processing Unit (CPU), a memory, and other electronic parts or components are mounted to the printed wiring board.

### SUMMARY

Now, there is the possibility that the battery pack comes away during the operation of the notebook-size personal computer, which brings about obstacles to the operation and the maintenance of the data. In order to cope with this situation, a slide manipulation portion with which attachment/detachment of the battery pack is safely carried out is normally provided on a back surface of the main body portion (main body unit) of the notebook-size personal computer. The slide manipulation portion provided on the back surface of the main body portion (main body unit) is manipulated, which results in that the battery can be readily and reliably attached/detached to/from the main body portion. As a result, when the supply of the electric power from the power source to the main body portion needs to be stopped, the supply of the electric power from the power source to the main body portion can be stopped by simply detecting the battery pack. For example, the battery pack can be simply detached from the main body portion in order to initialize a microcontroller within the battery pack, or in order to safely replace the memory with another one.

Here, it is supposed that for the purpose of enhancing a beautiful sight of an exterior appearance of the back surface of the main body portion of the notebook-size personal computer, the main body unit is equipped with the battery pack, the drive class, the memory, and the like which are disposed close to one another inside the main body unit, and which are covered with a cover fixed to the main body unit by the screwing. When the cover which collectively covers the battery pack, the drive class, the memory, and the like is fixed to the main body unit by the screwing, since it is unnecessary to provide a slide mechanism for the slide manipulation portion, and a space thereof, the back surface of the main body portion becomes simple, and thus the beautiful sight of the exterior appearance of the back surface of the main body portion is enhanced. However, during the attachment/detachment of the battery pack, a screw (male screw) needs to be detached to open the cover from the main body unit, which makes the smooth detachment and re-attachment of the battery pack difficult.

The present disclosure has been made in order to solve the problems described above, and it is therefore desirable to produce the same state of stop of supply of an electric power from a power source as that in the case where a battery pack is detached without detaching the battery pack in an information processor such as a notebook-size personal computer.

In order to attain the desire described above, according to an embodiment of the present disclosure, there is provided an information processor including: a detecting portion detecting connection between a battery pack and an information processor main body, and outputting connection information to the battery pack; a power source circuit to which an electric power is supplied from the battery pack acquiring the connection information; a manipulation portion adapted to be manipulated by a user; and a stopping portion outputting un-connection information to the battery pack when the manipulation portion is manipulated, and stopping output of the connection information even when the connection is detected by the detecting portion.

According to another embodiment of the present disclosure, there is provided an information processor including: a detecting portion detecting connection between a battery pack and an information processor main body, and outputting connection information to the battery pack; the battery pack supplying an electric power to the information processor main body when the connection information is acquired; a manipulation portion adapted to be manipulated by a user; and a stopping portion outputting un-connection information to the battery pack when the manipulation portion is manipulated, and stopping output of the connection information even when the connection is detected by the detecting portion.

According to the embodiments of the present disclosure, when the manipulation portion provided in the information processor is manipulated in the state in which the battery pack and the information processor main body are connected to each other, the un-connection information is outputted to the battery pack. As a result, the supply of the electric power from the battery pack to the information processor main body is stopped.

As set forth hereinabove, according to the present disclosure, the same effects as those in the case where the battery pack is detached can be obtained without detaching the battery pack from the information processor.

### BRIEF DESCRIPTION OF THE DRAWINGS

FIG. 1 is a perspective view in a state in which a cover is attached to a back surface of an information processor (notebook-size personal computer) according to a first embodiment of the present disclosure;

FIG. 2 is a perspective view in a state in which the cover is detached from the back surface of the information processor according to the first embodiment of the present disclosure;

FIG. 3 is a top plan view in the state in which the cover is attached to the back surface of the information processor according to the first embodiment of the present disclosure;

FIG. 4 is a top plan view in the state in which the cover is detached from the back surface of the information processor according to the first embodiment of the present disclosure;

FIG. 5 is an enlarged top plan view showing a portion in the vicinity of a hole for a manipulation portion formed in the back surface of the information processor according to the first embodiment of the present disclosure;

FIG. 6 is a cross sectional view taken on line X-X of FIG. 5; and

FIG. 7 is a circuit diagram, partly in block, showing a configuration of a power source control circuit of the information processor according to the first embodiment of the present disclosure.

### DETAILED DESCRIPTION OF THE PREFERRED EMBODIMENTS

Embodiments of the present disclosure will be described in detail hereinafter with reference to the accompanying drawings. The embodiments will be each described by giving a notebook-size personal computer as an information processor. It is noted that constituent elements common to the drawings are designated by the same reference numerals or symbols, respectively, and a repeated description thereof is omitted for the purpose of sake of simplicity. Also, it is noted that the description will be given below in accordance with the following order:
1. Exterior Appearance of Information Processor (First Embodiment);
2. Configuration of Manipulation Portion;
3. Configuration of Power Source Control Circuit;
4. Operation of Power Source Control Circuit; and
5. Second Embodiment

### 1. Exterior Appearance of Information Processor

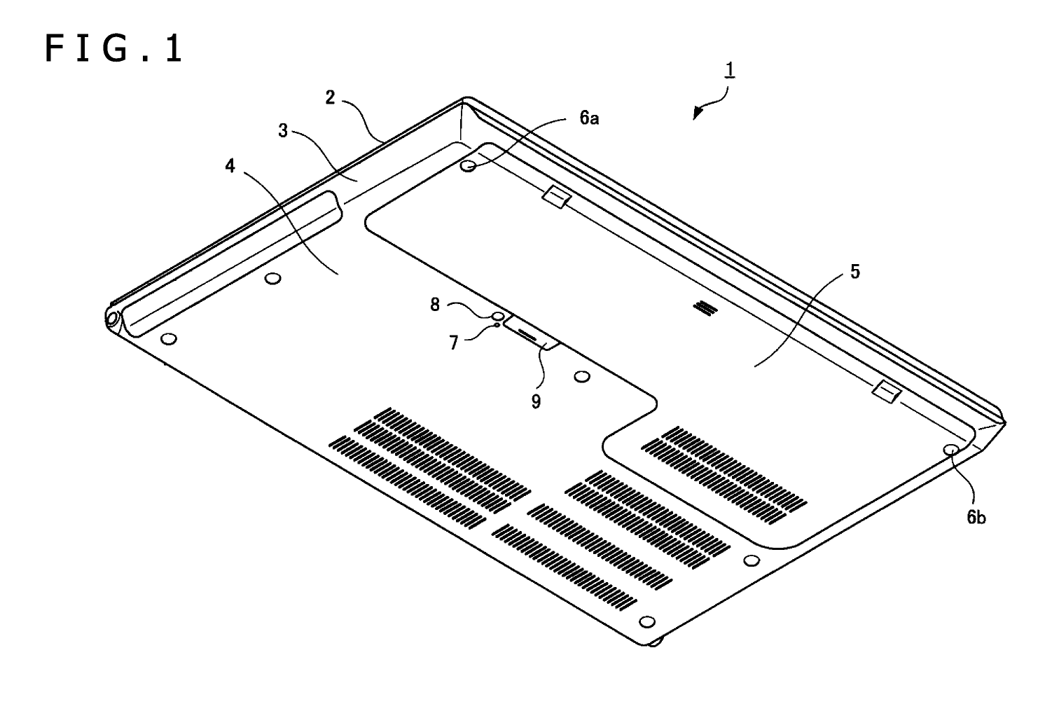

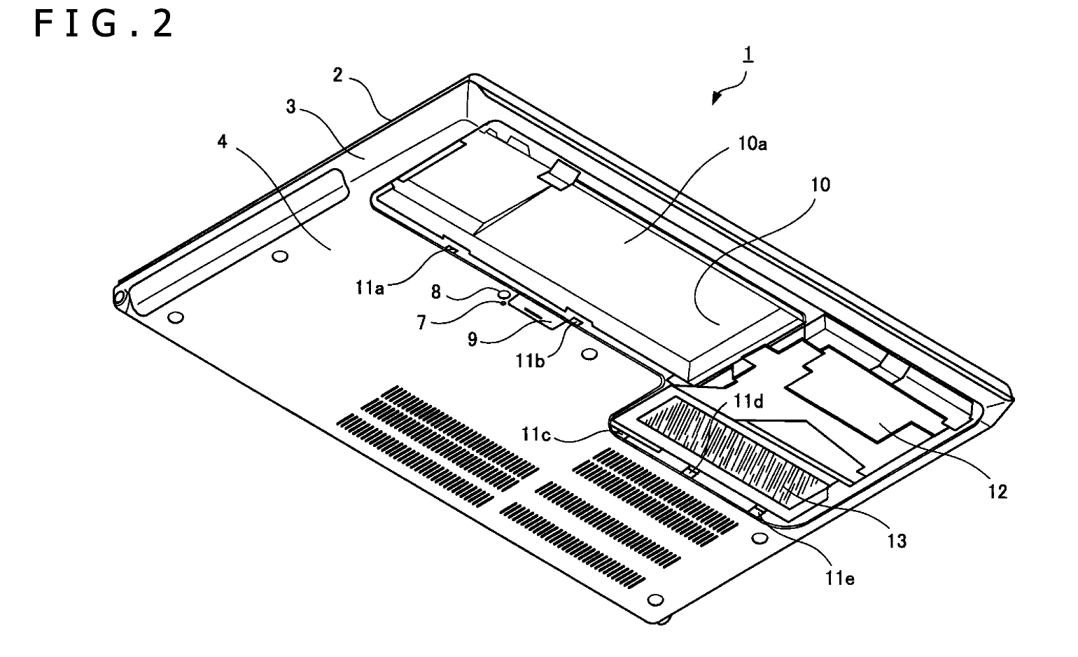

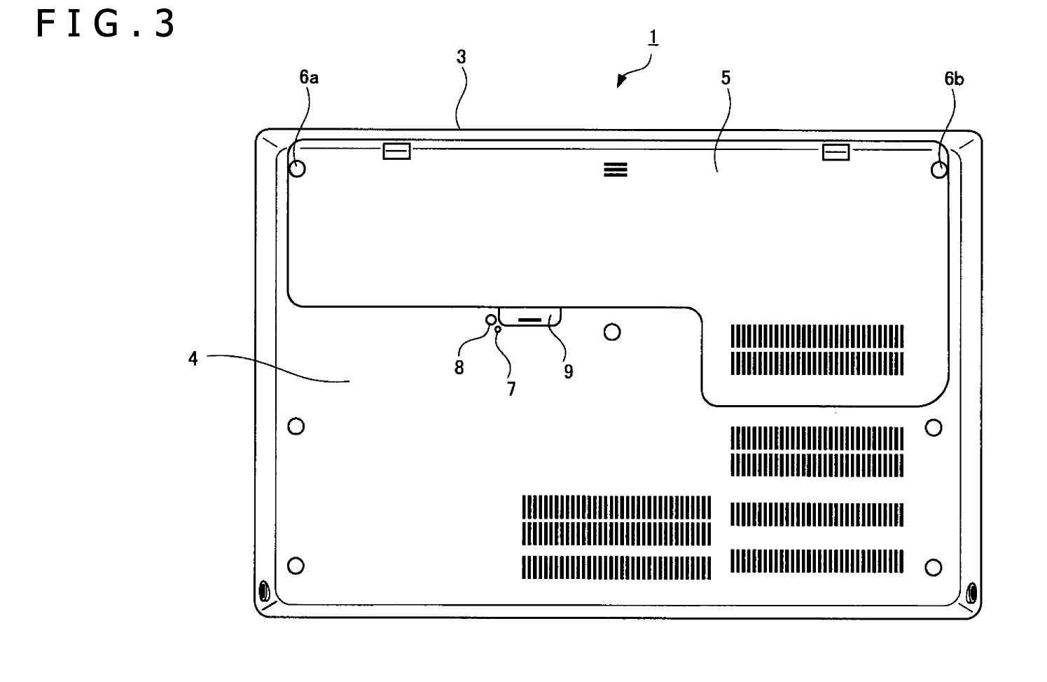

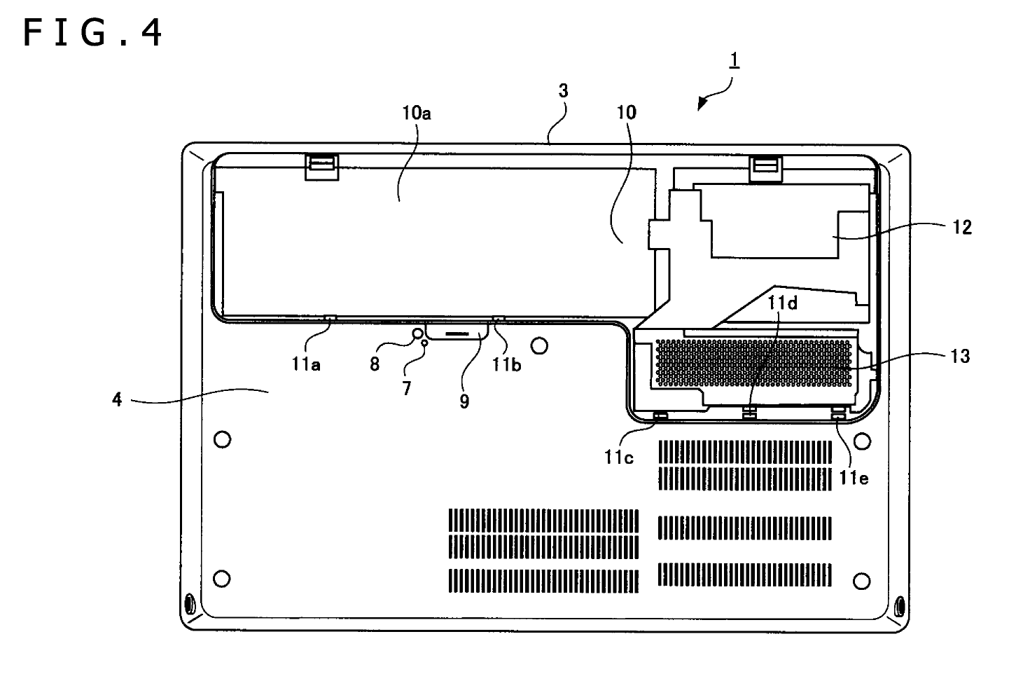

FIG. 1 is a perspective view showing a state in which a notebook-size personal computer as an information processor, according to a first embodiment of the present disclosure, having a back surface to which a cover is attached is looked up from a lower side. FIG. 2 is a perspective view showing a state in which the notebook-size personal computer as the information processor, according to the first embodiment of the present disclosure, having the back surface from which the cover is detached is looked up from the lower side. FIG. 3 is a top plan view in the state in which the cover is attached to the back surface of the notebook-size personal computer according to the first embodiment of the present disclosure. Also, FIG. 4 is a top plan view in the state in which the cover is detached from the back surface of the notebook-size personal computer according to the first embodiment of the present disclosure. In FIGS. 3 and 4, the lower side corresponds to a front surface side of the notebook-size personal computer 1 when viewed from a user, and an upper side corresponds to a back surface side of the notebook-size personal computer 1 when viewed from the user.

The notebook-size personal computer 1 includes a display portion 2, a main body portion 3, and a hinge (not shown) connecting the display portion 2 and the main body portion 3 to each other.

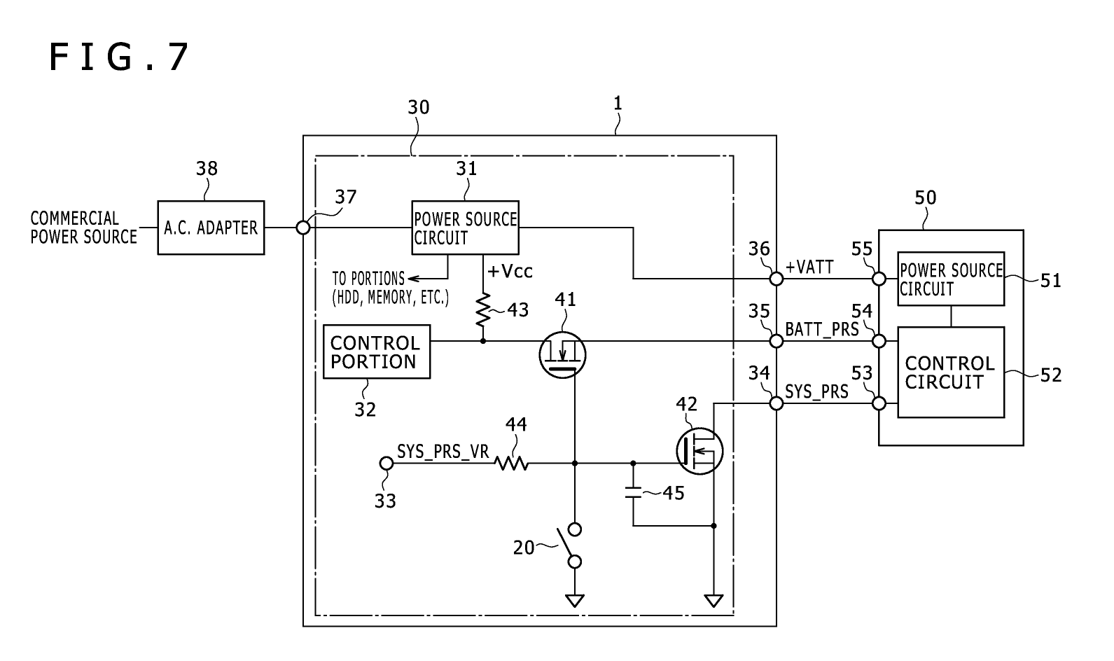

The display portion 2 can be opened and closed with respect to the main body portion 3 through the hinge. The display portion 2 has a display panel (not shown) becoming a screen for displaying thereon information, and in a close state, the display panel faces the main body portion 3. The information which is displayed on the display panel is generated from a display processing unit (not shown) which is provided within a chassis of the display portion 2, and which executes display processing in accordance with the control made by a control portion (refer to FIG. 7) provided in the main body portion 3.

The main body portion 3 includes a palm rest unit (keyboard unit) (not shown) and a main body unit 4. In this case, the palm rest unit composes an upper surface side portion of the main body portion 3. Also, the main body unit 4 composes a bottom surface side portion of the main body portion 3. The palm rest unit and the main body unit 4 are combined with each other to be integrated into the main body portion 3.

The main body unit 4 is equipped with a printed wiring board to which plural electronic parts or components, and the like are mounted, a heat dissipation unit, a drive class such as a hard disc drive, and the like. A Central Processing Unit (CPU), a memory, and other electronic parts or components are mounted to the printed wiring board.

The notebook-size personal computer 1 includes a battery pack 50 (refer to FIG. 7) which is detachably attached to the main body portion 3 (the main body unit 4). A lithium ion polymer battery or the like, for example, is used as the battery pack 50. As shown in FIGS. 2 and 4, a concave space 10 to/from which the battery pack 50 can be attached/detached is provided in the vicinity of a back surface of the main body portion 3 (the main body unit 4) of the notebook-size personal computer 1. The concave space 10 is sorted into a battery attachment portion 10a, an HDD attachment portion, and a memory attachment portion. In FIGS. 2 and 4, there is shown a state in which the battery pack 50 is detached from the battery attachment portion 10a, and an HDD 12 (an example of an auxiliary storage device), and a memory 13 (an example of a main recording device) are attached to the HDD attachment portion and the memory attachment portion, respectively.

Engagement holes 11a to 11e are provided in parts of an edge of the concave space 10 of the main body unit 4, respectively. The engagement holes 11a to 11e are engaged with engagement protrusions (not shown) of the cover 5, respectively, to place the cover 5 on the main body unit 4 so as to cover the concave space 10. In this state, screws 6a and 6b (refer to FIGS. 1 and 3) are screwed, thereby making it possible to attach (fix) the cover 5 to the main body unit 4. In the embodiment, the battery pack, the HDD 12, and the memory 13 are all accommodated in the concave space 10, and are then covered with one cover 5, and the cover is attached to the main body unit 4 by the screwing. As a result, the large cover 5 comes to appear as a part of the exterior packing surface of the back side of the main body unit 4. Thus, the beautiful sight of the exterior appearance is further enhanced in the case of the embodiment than in the case where the battery pack, the HDD 12, and the memory 13 are accommodated in the different spaces, and are then covered with plural covers, respectively, and the plural covers are attached by the screwing.

It is noted that although in the embodiment, the cover 5 is fixed to the main body unit 4 by the screwing so that the cover 5 can be detached from the main body unit 4 during repair/replacement of the battery or the like, the present disclosure is by no means limited thereto as long as the cover 5 is fixed to the main body unit 4 so that the cover does not readily come away from the main body unit 4 during normal use by the user. Bonding, welding or the like, for example, is given as means for fixing the cover 5 to the main body unit 4.

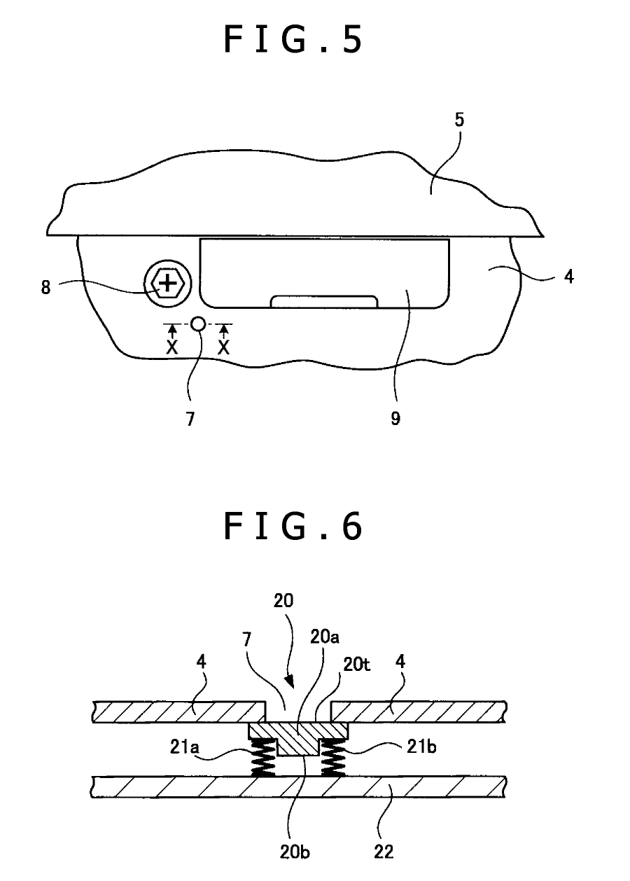

A hole 7 formed in the main body unit 4 is used to insert thereinto a slender rod-like member when the user pushes a manipulation portion provided in the main body unit 4. FIG. 5 shows a top plan view enlarging a portion in the vicinity of the hole 7 for the manipulation portion on the back surface of the notebook-size personal computer 1. A screw 8 is used to fix the main body unit 4 to the palm rest unit. In addition, the cover 5 is detached from the main body unit 4, and a docking station (functionality expansion unit) is then connected to the notebook-size personal computer 1, thereby making it possible to expand the function of the notebook-size personal computer 1.

### 2. Configuration of Manipulation Portion

Next, a description will be given with respect to an outline of the manipulation portion provided inside the main body unit 4.

FIG. 6 is a cross sectional view taken on line X-X of FIG. 5. The notebook-size personal computer 1 includes a button 20 as the manipulation portion between the chassis of the main body unit 4, and a printed wiring board 22 with which the main body unit 4 is equipped. The button 20 has a button main body 20a having a convex shape protruding downward in cross section. Elastic members 21a and 21b are both provided between the button main body 20a, and the printed wiring board 22. When the user inserts a slender rod-like member into the hole 7 to push an upper surface 20t of the button main body 20a, so that when a lower surface 20b of the button main body 20a comes in contact with a wiring portion or the like of the printed wiring board 22, the button 20a is set to an ON state. With regard to an operation of the button 20, when the user keeps the slender rod-like member from the button main body 20a, the lower surface 20b of the button main body 20a departs from the wiring portion or the like of the printed wiring board 22 by elastic forces of the elastic members 21a and 21b.

As described above, the button 20 needs to be manipulated by inserting the slender rod-like member into the hole 7. In a manner of speaking, since the button 20 is constructed and disposed so as to be hidden, it may be impossible for the user to readily manipulate the button 20. Therefore, in the normal use, the user is prevented from manipulating the button 20 by mistake, and thus the mal-manipulation can be prevented. While the button 20 is pushed, there are obtained the same effects as those in the case where the battery pack 50 is detached from the main body unit 4 by a power source control circuit 30 which will be described later.

It is noted that the button 20 shown in FIG. 6 is an example of the manipulation portion, and thus all it takes is that the manipulation portion is turned ON when the user manipulates the manipulation portion, and is held in an OFF state while the user does not manipulate the manipulation portion, and has the construction and disposition which the user cannot readily manipulate.

### 3. Configuration of Power Source Control Circuit

Next, the power source control circuit 30 in the notebook-size personal computer will be described with reference to FIG. 7.

Referring to FIG. 7, the battery pack 50 is attached to the battery equipment portion 10a (refer to FIGS. 2 and 4) of the notebook-size personal computer 1. An A.C. adapter 38 is connected to the notebook-size personal computer 1, and thus an A.C. voltage which has been inputted from a commercial utility power source is converted into a D.C. voltage by the A.C. adapter 38, and the resulting D.C. voltage is supplied to the notebook-size personal computer 1.

The notebook-size personal computer 1 includes the power source control circuit 30 for carrying out the control and switching of the electric power inputted from the battery pack 50, and the electric power inputted from the A.C. adapter 38, and transmitting/receiving a signal to/from the battery pack 50. The power source control circuit 30 includes a power source circuit 31, a control portion 32, the button 20, re-channel Metal-Oxide-Semiconductor Field-Effect Transistors (MOSFETs) 41 and 42, resistors 43 and 44, and a capacitor 45. Although in the first embodiment, the n-channel MOSFET (hereinafter referred to as “the nMOSFET” for short) is used as an example of a switching element, the present disclosure is by no means limited to this example. All it takes is that an ON state and an OFF state can be electrically switched over to each other, and thus any other suitable transistor or any other suitable switching element can also be used.

One input terminal of the power source circuit 31 of the power source control circuit 30 is connected to a terminal 37 (power source terminal) which is in turn connected to a plug of the A.C. adapter 38. In addition, the other terminal of the power source circuit 31 is connected to a terminal 36. Moreover, the power source circuit 31 is connected to a drain terminal of the nMOSFET 41 through the resistor 43, and the drain terminal of the nMOSFET 41 is connected to an input terminal of the control portion 32. A source terminal of the nMOSFET 41 is connected to a terminal 35. In addition, a gate terminal of the drain terminal of the nMOSFET 41 is connected to a terminal 33 of the resistor 44, and is also connected to the ground through the button 20. The gate terminal of the nMOSFET 41 is further connected to a gate terminal of the nMOSFET 42. A gate terminal of the nMOSFET 42 is connected to the ground through the capacitor 45, and a source terminal of the nMOSFET 42 is directly connected to the ground. A drain terminal of the nMOSFET 42 is connected to a terminal 34.

An ON/OFF operation of the nMOSFETs 41 and 42 (examples of a detecting portion and a stopping portion) is controlled in accordance with either a signal SYS_PRS_VR inputted through the terminal 33 or an ON/OFF operation of the button 20. The signal SYS_PRS_VR inputted through the terminal 33 can be outputted even in a phase of non-connection between the battery pack 50 and the A.C. adapter 38 because of use of an RTC battery held inside the notebook-size personal computer 1. Resistance values of the resistors 43 and 44, and a capacitance value of the capacitor 45 are determined depending on the ratings of the nMOSFETs 41 and 42, and values of the signal SYS_PRS_VR and a +Vcc.

The battery pack 50 includes a power source circuit 51 including a battery (not shown), and a control circuit 52 connected to the power source circuit 51. The control circuit 52 is connected to each of terminals 53 and 54, and the power source circuit 51 is connected to a terminal 55. The terminals 53, 54, and 55 of the battery pack 50 are connected to the terminals 34, 35, and 36 of the notebook-size personal computer 1 in one-to-one correspondence manner. The terminals 34, 35, and 36 are provided in a connector (not shown) disposed in the battery attachment portion 10a, and the terminals 53, 54, and 55 are provided in a connector (not shown) disposed in the battery pack 50. The connector of the notebook-size personal computer 1, and the connector of the battery pack 50 are connected to each other, which results in that the terminals 34, 35, and 36, and the terminals 53, 54, and 55 corresponding to the terminals 34, 35, and 36, respectively, are connected to one another.

The power source circuit 31 of the power source control circuit 30 supplies the electric power to the power source control circuit 30, and supplies the electric power to the HDD 12, the memory 13 on the printed wiring board, and the like by utilizing the electric power supplied thereto either from the A.C. adapter 38 or from the battery pack 50. In addition, the power source circuit 31 supplies the signal SYS_PRS_VR to the terminal 33. The power source circuit 31 carries out the switching of the electric power supplied thereto either from the A.C. adapter 38 or from the battery pack 50 in accordance with the control made by the control portion 32. The control portion 32 is a block for controlling the power source control circuit 30, and an Embedded Controller (EC), for example, is used as the control portion 32.

For example, when an electric power +VBATT is supplied from the battery pack 50 to the power source circuit 31 through the terminal 36, the control portion 32 uses the electric power supplied thereto from the battery pack 50. In addition, for example, when the electric powers are supplied from both of the A.C. adapter 38 and the battery pack 50 to the power source circuit 31, the control portion 32 uses the electric power supplied thereto from the A.C. adapter 38, and also charges the battery of the battery pack 50 with the electricity. The form of the switching of the electric power from the A.C. adapter 38, and the battery pack 50 in the power source 31 is merely an example, and thus the present disclosure is by no means limited to the example.

A signal SYS_PRS outputted from the terminal 34 of the notebook-size personal computer 1 is set to a Low level by the nMOSFET 42 having the gate terminal to which the signal SYS_PRS_VR is inputted, that is, set to approximately a zero level in a phase of connecting the battery pack 50 to the notebook-size personal computer 1. As a result, the control circuit 52 of the battery pack 50 detects that the notebook-size personal computer 1 is connected to the battery pack 50 through the terminal 53. It is noted that the Low level is 0 V, and a High level (a voltage for a drain saturated current), for example, is 3.3 V.

A signal BATT_PRS inputted to the terminal 35 of the notebook-size personal computer 1 is set to the Low level by the nMOSFET 41 on the battery pack 50 side, that is, set to approximately the zero level in a phase of connecting the battery pack 50 to the notebook-size personal computer 1. As a result, the control circuit 32 of the notebook-size personal computer 1 detects that the battery pack 50 is connected to the notebook-size personal computer 1 through the terminal 35 and the nMOSFET 41.

The electric power +VBATT is an electric power which is outputted from the power source circuit 51 of the battery pack 50 to the power source circuit 31 of the notebook-size personal computer 1. Only when the battery pack 50 is connected to the notebook-size personal computer 1, the electric power +VBATT is outputted from the power source circuit 51. On the other hand, when the battery pack 50 is un-attached to the notebook-size personal computer 1 or the button 20 is held in the ON state (the button main body 20a is held depressed), no electric power +VBATT is outputted from the power source circuit 51.

### 4. Operation of Power Source Control Circuit

Operations of the power source control circuit 30 will now be described so as to correspond to three conditions: (1) in a phase of attaching the battery pack 50 to the notebook-size personal computer 1; (2) in a phase of un-attaching the battery pack 50 to the notebook-size personal computer 1; (3) in a phase of depressing the button 20.

### (In Phase of Attaching Battery Pack 50 to Notebook-Size Personal Computer 1)

Firstly, a description will be given to the case where the battery pack 50 is attached to the notebook-size personal computer 1. At this time, it is supposed that the A.C. adapter 38 is not connected to the notebook-size personal computer 1.

The signal SYS_PRS_VR is supplied from the power source circuit 31 to each of the gate terminals of the nMOSFETs 41 and 42 through the terminal 33 and the resistor 44 to turn ON each of the nMOSFETs 41 and 42. The nMOSFET 42 is turned ON, which results in that a signal SYS_PRS flowing through the terminal 34 on the notebook-size personal computer 1 side (the terminal 53 on the battery pack 50 side) is set to the Low level. When the battery pack 50 is attached to the notebook-size personal computer 1, the signal SYS_PRS set to the Low level corresponds to connection information representing that the notebook-size personal computer 1 is connected to the battery pack 50.

Also, the control circuit 52 of the battery pack 50 detects that the notebook-size personal computer 1 is connected to the battery pack 50 based on the connection information, and the control circuit 52 sends a control signal to the power source circuit 51 so as for the power source circuit 51 to output the electric power +VBATT. In response to the control signal, the power source circuit 51 outputs the electric power +VBATT to the notebook-size personal computer 1. In addition, on the battery pack 50 side, a signal BATT_PRS flowing through the terminal 54 (the terminal 35 on the notebook-size personal computer 1 side) is set to the Low level, which results in that the control portion 32 of the notebook-size personal computer 1 detects that the battery pack 50 is connected to the notebook-size personal computer 1.

### (In Phase of Un-Attaching Battery Pack 50 to Notebook-Size Personal Computer 1)

Next, a description will be given to the case where the battery pack 50 is un-attached to the notebook-size personal computer 1. At this time, it is supposed that the A.C. adapter 38 is connected to the notebook-size personal computer 1.

When the battery pack 50 is un-attached to the notebook-size personal computer 1, since the battery pack 50 and the notebook-size personal computer 1 are not connected to each other, each of the terminals 34 to 36 of the notebook-size personal computer 1 is held in the open state. Even when the signal SYS_PRS_VR is supplied to each of the gate terminals of the nMOSFETs 41 and 42 through the terminal 33 and the resistor 44 to turn ON each of the nMOSFETs 41 and 42, the battery pack 50 and the notebook-size personal computer 1 are not connected to each other. For this reason, the signal SYS_PRS flowing through the terminal 53 on the battery pack 50 side becomes the High level. The signal SYS_PRS set to the High level corresponds to un-connection information representing that the notebook-size personal computer 1 is not connected to the battery pack 50.

Also, the control circuit 52 of the battery pack 50 detects that the notebook-size personal computer 1 is connected to the battery pack 50 based on the un-connection information, and the control circuit 52 does not send a control signal in accordance with which the electric power +VBATT is outputted to the power source circuit 51. As a result, the power source circuit 51 does not output the electric power +VBATT to the notebook-size personal computer 1. In addition, on the battery pack 50 side, the signal BATT_PRS flowing through the terminal 54 (the terminal 35 on the notebook-size personal computer 1 side) is set to the High level, which results in that the control portion 32 of the notebook-size personal computer 1 detects that the battery pack 50 is un-connected to the notebook-size personal computer 1.

### (In Phase of Depressing Button 20)

Next, a description will be given with respect to the case where the user depresses the button 20 (refer to FIG. 6) on the back side of the notebook-size personal computer 1. At this time, it is supposed that the battery pack 50 is connected to the notebook-size personal computer 1, and the A.C. adapter 38 is not connected to the notebook-size personal computer 1.

While the button 20 on the back surface of the notebook-size personal computer 1 is depressed to be held in the ON state, each of the gate terminals of the nMOSFETs 41 and 42 is connected to the ground. As a result, the signal SYS_PRS_VR is not inputted from the power source circuit 31 to each of the gate terminals of the nMOSFETs 41 and 42 through the terminal 33 and the resistor 44, and thus the nMOSFET 42 is turned OFF. The nMOSFET 42 is turned OFF, which results in that the signal SYS_PRS flowing through the terminal 34 on the notebook-size personal computer 1 side (the terminal 53 on the battery pack 50 side) is not set to the Low level, but becomes the High level. The signal SYS_PRS set to the High level corresponds to the un-connection information representing that the notebook-size personal computer 1 is not connected to the battery pack 50.

Also, the control circuit 52 of the battery pack 50 detects that the notebook-size personal computer 1 is not connected to the battery pack 50 based on the un-connection information, and stops the output of the control signal in accordance with which the electric power +VBATT is outputted to the power source circuit 51. As a result, the power source circuit 51 stops the output of the control signal to the notebook-size personal computer 1. In addition, on the battery pack 50 side, even when the signal BATT_PRS flowing through the terminal 54 (the terminal 35 on the notebook-size personal computer 1 side) is set to the Low level, since the nMOSFET 42 is held in the OFF state, the control portion 32 of the notebook-size personal computer 1 recognizes that the battery pack 50 is un-connected to the notebook-size personal computer 1.

Hereinafter, TABLE 1 shows states of the signal SYS_PRS, the signal BATT_PRS, and the electric power +VBATT in the three conditions: (1) in the phase of attaching the battery pack 50 to the notebook-size personal computer 1; (2) in the phase of un-attaching the battery pack 50 to the notebook-size personal computer 1; (3) in the phase of depressing the button 20.

TABLE 1

| | BATT_PRS | | |
|---|---|---|---|
| | (NOTEBOOK- | SYS_PRS | +VBATT |
| | SIZE PC | (BATTERY | (BATTERY |
| | SIDE) | PACK SIDE) | PACK SIDE) |
| BATTERY PACK | LOW | LOW | OUTPUT |
| EQUIPMENT | | | |
| BATTERY PACK | HIGH | HIGH | UN-OUTPUT |
| UN-EQUIPMENT | | | |
| DEPRESS BUTTON | HIGH | HIGH | UN-OUTPUT |

As shown in TABLE 1, the three states of the signal SYS_PRS, the signal BATT_PRS, and the electric power +VBATT in the phase of un-attaching the battery pack 50 to the notebook-size personal computer 1 are the same as those of the signal SYS_PRS, the signal BATT_PRS, and the electric power +VBATT in the phase of depressing the button 20, respectively. That is to say, while the button 20 is depressed by the user, the same state as that in which the battery pack 50 is detected from the notebook-size personal computer 1 is produced in a pseudo manner.

That is to say, while the button 20 is depressed by the user, the signal SYS_PRS is outputted to the control circuit 52 of the battery pack 50, thereby resetting the control circuit 52 of the battery pack 50. As a result, the output of the electric power +VBATT from the power source circuit 51 of the battery pack 50 is stopped. Also, when the depressing of the button 20 is stopped without detaching the battery pack 50 from the notebook-size personal computer 1, the output of the electric power +VBATT from the power source circuit 51 of the battery pack 50 is restarted. The button 20 is manipulated in such a way, whereby the same effect as that in the case where the battery pack 50 is detected from the notebook-size personal computer 1, and is then attached thereto again can be obtained without detaching the battery pack 50 from the notebook-size personal computer 1.

### (Connection of Only Battery Pack 50 in Phase of Depressing Button 20)

It is noted that in the embodiment described above, the communication is made between the notebook-size personal computer 1 and the battery pack 50, and the signal SYS_PRS and the signal BATT_PRS are detected on the battery pack 50 side and on the notebook-size personal computer 1 side, respectively. However, when only the battery pack 50 is connected to the notebook-size personal computer 1, only the battery pack 50 supplies the electric power to the notebook-size personal computer 1. In this case, it is only necessary to control the output of the electric power +VBATT by the battery pack 50. Therefore, all it takes is that the state of the signal SYS_PRS can be detected on the battery pack 50 side, and thus a configuration may also be adopted such that the signal BATT_PRS is not detected on the notebook-size personal computer 1 side.

For example, since the control portion 32 controls the charging, the discharging or the like which is made between the notebook-size personal computer 1 and the battery pack 50, when the operation of the control portion 32 is not normal, the resetting (initialization) of the control portion 32 is also necessary. For this reason, it is also possible to adopt a configuration such that whether or not the battery pack 50 is connected to the notebook-size personal computer 1 can be recognized based on the result of the detection of the state of the signal BATT_PRS on the notebook-size personal computer 1 side, and when it is recognized that the battery pack 50 is not connected to the notebook-size personal computer 1, the control portion 32 is reset. In addition, since the control circuit 52 controls the charging, the discharging or the like of the battery pack 50, when the operation of the control circuit 52 is not normal, the resetting (initialization) of the control circuit 52 is also necessary. For this reason, it is also possible to adopt a configuration such that whether or not the notebook-size personal computer 1 is connected to the battery pack 50 can be recognized based on the result of the detection of the state of the signal SYS_PRS on the battery pack 50 side, and when it is recognized that the battery pack 50 is not connected to the notebook-size personal computer 1, the control circuit 52 is reset.

(Connection is Made between Battery Pack 50 and A.C. Adapter 38 in Phase of Depressing Button 20)

Although the A.C. adapter 38 is preferably, previously detached from the notebook-size personal computer 1 in the phase of manipulating the button 20, there is also the possibility that the user manipulates the button 20 with the A.C. adapter 38 being attached to the notebook-size personal computer 1 by mistake. That is to say, in the phase of depressing the button 20, both of the battery pack 50 and the A.C. adapter 38 are attached to the notebook-size personal computer 1 in some cases. In such cases, the control portion 32 of the notebook-size personal computer 1 carries out the control for both of the battery pack 50 and the A.C. adapter 38.

For example, since the control circuit 52 controls the charging, the discharging or the like of the battery pack 50, when the operation of the control circuit 52 is not normal, the resetting (initialization) of the control circuit 52 is also necessary. For this reason, it is also possible to adopt a configuration such that whether or not the notebook-size personal computer 1 is connected to the battery pack 50 can be recognized based on the result of the detection of the state of the signal SYS_PRS on the battery pack 50 side, and when it is recognized that the battery pack 50 is not connected to the notebook-size personal computer 1, the control circuit 52 is reset.

It is noted that the power source circuit 31 in the first embodiment, as an example, includes a charging circuit using a capacitor or the like in its inside. As a result, even when the battery pack 50 is detached from the notebook-size personal computer 1 in the state in which the A.C. adapter 38 is not connected to the notebook-size personal computer 1, the charging circuit carries out the discharge, whereby the necessary electric power such as an electric power for the voltage +Vcc can be supplied to the necessary circuit for given seconds (for example, 1 second). As a result, the moment the battery pack 50 is detached from the notebook-size personal computer 1 and after the battery pack 50 is detached from the notebook-size personal computer 1, the power source control circuit 30 reliably operates. For this reason, blocks (not shown) within the notebook-size personal computer 1 safely operate.

In addition, in the embodiment described above, the case where the battery pack, the drive class such as the HDD, the memory, and the like are collectively accommodated in the notebook-size personal computer 1, and are covered with one cover. However, the present disclosure can also be applied to the case where two or more covers are used or the case where such a cover is not fixed to the main body unit by the screwing.

### 5. Second Embodiment

An information processor according to a second embodiment of the present disclosure includes: the detecting portion 42 for detecting the connection between the battery pack 50 and the information processor main body 2, and outputting the connection information to the battery pack 50; the battery pack 50 for supplying the electric power to the information processor main body 3 when the connection information is acquired; the manipulation portion 20 adapted to be manipulated by the user; and the stopping portion 42 for outputting the connection information to the battery pack 50 when the manipulation portion 20 is manipulated, and stopping output of the connection information even when the connection is detected by the detecting portion 42.

It should be noted that the present disclosure is by no means limited to the embodiments described above, and carious other changes and application examples can be made without departing from the subject matter of the present disclosure described in the appended claims.

The present disclosure contains subject matter related to that disclosed in Japanese Priority Patent Application JP 2010-283252 filed in the Japan Patent Office on Dec. 20, 2010, the entire content of which is hereby incorporated by reference.

What is claimed is:

1. An information processor, comprising:
a detecting portion detecting connection between a battery pack and an information processor main body, and outputting connection information to said battery pack;
a power source circuit to which an electric power is supplied from said battery pack acquiring the connection information;
a manipulation portion adapted to be manipulated by a user; and
a stopping portion outputting un-connection information to said battery pack when said manipulation portion is manipulated, and stopping output of the connection information even when the connection is detected by said detecting portion.

2. The information processor according to claim 1, wherein said battery pack is accommodated in a concave space provided in said information processor main body, and is fixed with a cover.

3. The information processor according to claim 2, wherein said cover is fixed to said information processor main body by a screw.

4. The information processor according to claim 2, wherein a device other than said battery pack is accommodated in said concave space.

5. The information processor according to claim 4, wherein said battery pack, a main recording device, and an auxiliary storage device are accommodated in said concave space.

6. The information processor according to claim 2, wherein a manipulation for said manipulation portion is carried out through a hole provided in said information processor main body, and said stopping portion outputs the un-connection information only while said manipulation portion is manipulated.

7. An information processor, comprising:
a detecting portion detecting connection between a battery pack and an information processor main body, and outputting connection information to said battery pack;
said battery pack supplying an electric power to said information processor main body when the connection information is acquired;
a manipulation portion adapted to be manipulated by a user; and
a stopping portion outputting un-connection information to said battery pack when said manipulation portion is manipulated, and stopping output of the connection information even when the connection is detected by said detecting portion.
